(19) United States
(12) Patent Application Publication
(10) Pub. No.: US 2014/0029772 A1
(43) Pub. Date: Jan. 30, 2014

(54) LOAD-RESISTING STRUCTURE OF MULTIFUNCTIONAL VIBRATION ACTUATOR

(71) Applicant: Takayuki Kumagai, Tokyo (JP)

(72) Inventor: Takayuki Kumagai, Tokyo (JP)

(73) Assignee: NAMIKI SEIMITSU HOUSEKI KABUSHIKI KAISHA, Tokyo (JP)

(21) Appl. No.: 14/009,081

(22) PCT Filed: Mar. 26, 2012
(86) PCT No.: PCT/JP2012/057687

§ 371 Date: Sep. 30, 2013

(30) Foreign Application Priority Data
Mar. 30, 2011 (JP) 2011-074756

(51) Int. Cl. H04R 1/02

(52) U.S. Cl. CPC H04R 1/02
USPC 381/162

(57) ABSTRACT

(Problem) Provided is a multifunctional vibration actuator capable of improving load resistance while maintaining high impact resistance and high space-saving provided according to a thin profile.

(Solution) By constructing an outer periphery section of a suspension to protrude from a housing, load resistance against external pressure is improved while a thin profile is maintained. Also, by integrating the suspension and the housing, the number of components is reduced, the attendant number of operations is reduced, and durability provided by an integrated structure is obtained.

### TECHNICAL FIELD

The present invention relates to a multifunctional vibration actuator which includes a magnetic circuit portion having a magnet and a vibration plate having a voice coil, the magnetic circuit portion being supported in a housing by using a suspension and the vibration plate being formed at an end of the housing, and has a sensory vibration generating function according to vibration of the magnetic circuit portion and a sound reproducing function according to vibration of the vibration plate, in response to an input to the voice coil.

### BACKGROUND ART

Currently, mobile communication devices represented by mobile phones have a sound reproducing function and a sensory vibration generating function for notifying a user of an incoming call via ringtone reproduction or sensory vibration. Also, in order to incorporate these two functions into a single device, a multifunctional vibration actuator having a magnetic circuit portion commonly used for both of the sound reproducing function and the sensory vibration generating function is used.

In such a multifunctional vibration actuator, a frequency band used when a signal is input to a voice coil is set to be around a resonant frequency of a diaphragm to which the voice coil is attached, and a magnetic circuit portion having a magnet attached to an inner wall of a housing via a suspension. Accordingly, reproducing of sound according to vibration of the diaphragm and generating of sensory vibration according to vibration of the magnetic circuit portion may be switched without using a mechanical switching structure.

Regarding structures of the multifunctional vibration actuator, the present applicant has filed patent applications and these have been published as Japanese Laid-Open Patent Publication No. 2007-175570 (hereinafter, referred to as Patent Reference 1) and Japanese Laid-Open Patent Publication No. 2009-027679 (hereinafter, referred to as Patent Reference 2). Here, the structures disclosed in Patent References 1 and 2 have a stopper function for preventing a magnetic circuit portion and a voice coil from contacting each other when an impact, e.g., fall, is applied to the structures.

### PRIOR ART REFERENCE

### Patent Reference

(Patent Reference 1) Japanese Laid-Open Patent Publication No. 2007-175570

(Patent Reference 2) Japanese Laid-Open Patent Publication No. 2009-027679

### DISCLOSURE OF THE INVENTION

### Technical Problem

In a structure disclosed in Patent Reference 1 having the above-described effects, it may be an issue that a diameter of a magnetic circuit portion is limited since a step portion for fixing an outer periphery section of a suspension is formed at a cover. Also, a multifunctional vibration actuator disclosed in Patent Reference 2 does not have such an issue that a diameter of a magnetic circuit is limited but have an issue that rigidity against an external stress is low. In detail, while a magnetic circuit portion supported via a suspension and a voice coil attached to a diaphragm are prevented from contacting each other on impact, such as a fall, a housing may fall down against a cover when an external stress is applied, for example, when an attached case body is pressed.

In this regard, load resistance was not considered to be important since an external force applied to a case body of a conventional mobile phone is barely applied to each component body. However, recently, as a mobile phone is thinned, an external force applied to a case body is directly applied to a mounted component. Thus, a large mounted component represented by a multifunctional vibration actuator needs to have high load resistance, as well as a thin profile and high impact resistance.

An object of the present invention is to provide a multifunctional vibration actuator capable of improving load resistance while having advantages of a conventional structure, which are a thin profile and high impact resistance.

### Technical Solution

In order to accomplish the object, a first aspect of the present invention stated in claim 1 provides a multifunctional vibration actuator having a dynamic structure in which a diaphragm to which a voice coil is attached is fixed to a housing having a cylindrical shape, a magnetic circuit portion is attached to an inner side of the housing via a suspension, and the magnetic circuit portion has a magnet, wherein the housing and a cover are fixed to each other while protruding an outer periphery section of the suspension from the cover accommodating the magnetic circuit portion.

A second aspect of the present invention provides a structure wherein the protruded suspension and the housing are integrally formed.

### Advantageous Effects

By using such a structure, a multifunctional vibration actuator according to the present invention is capable of improving load resistance against an external stress while maintaining advantages of a conventional structure. In detail, by configuring an outer periphery section of a suspension to protrude from a cover, falling down of a housing against the cover may be prevented by the outer periphery section of the suspension.

Here, by using the structure that the outer periphery section of the suspension receives the external stress, the external stress that has been applied to the housing formed of a resin material is applied to the outer periphery section of the suspension formed of a metal material, and thus falling down of the housing due to a deformation occurring under a load application is prevented.

Also, by using the structure of the outer periphery section of the suspension protruding from the cover, the structure of the present invention may prevent the housing from falling down by an uneven load while preventing the housing from falling down by an even load. Here, since a protruding outer periphery section of the housing covers location misalignment of the suspension occurred when an uneven load is applied, stable and improved load resistance that does not depend upon a mount location in an attached case body may be obtained. Also, since the external stress is applied to the suspension, high durability may be maintained even when the external stress is repeatedly applied.

In addition, since the multifunctional vibration actuator according to the present invention has the above effects by using a suspension structure, an additional component is not required. Accordingly, load resistance may be improved while maintaining advantages of the conventional structure, such as a thin profile.

Also, by using a structure described in a second aspect of the present invention, the housing is reinforced by the suspension. Thus, the housing may be prevented from being detached by the external stress, and overall rigidity may be increased.

### BRIEF DESCRIPTION OF THE DRAWINGS

FIG. 1 is an overall perspective view of a multifunctional vibration actuator according to an embodiment of the present invention;

FIG. 2 is a lateral cross-sectional view taken along a line A-A′ of FIG. 1;

FIG. 3 is an exploded perspective view of a multifunctional vibration actuator according to an embodiment of the present invention; and

FIG. 4 is an expanded view of the vicinity of a protruding portion of FIG. 2.

### LIST OF REFERENCE NUMERALS

1: Grill
2: Diaphragm
3: Voice Coil
4: Housing
5: Suspension
6: Pole Piece
7: Magnet
8: Yoke
9: Weight
10: Terminal
11: Cover
C: Protruding Portion
D: Outer Periphery Section of Suspension
E: Yoke Brim Portion
f: Gap
g: Magnetic Gap

### BEST MODE FOR CARRYING OUT THE INVENTION

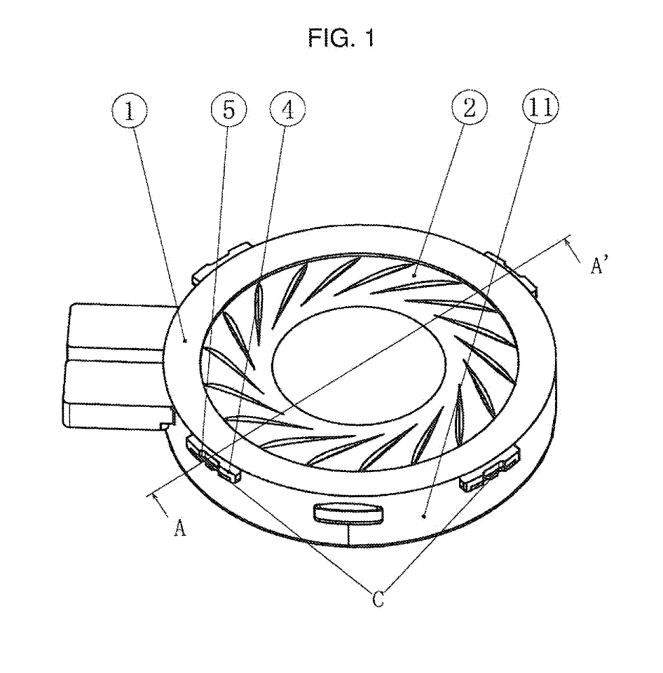

Hereinafter, one or more embodiments of the present invention will be described with reference to FIGS. 1, 2, and 3.

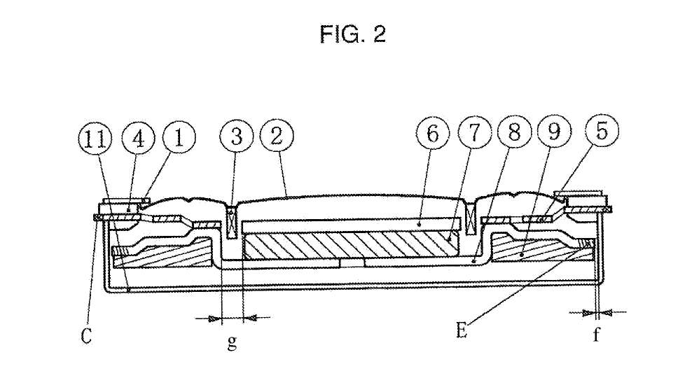

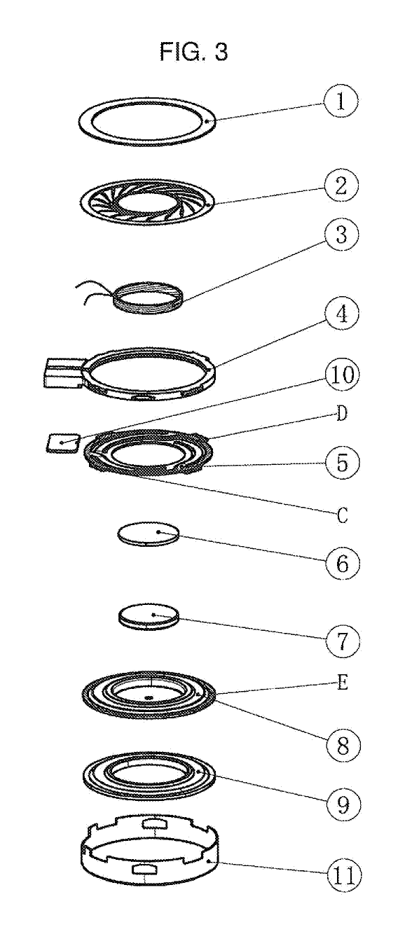

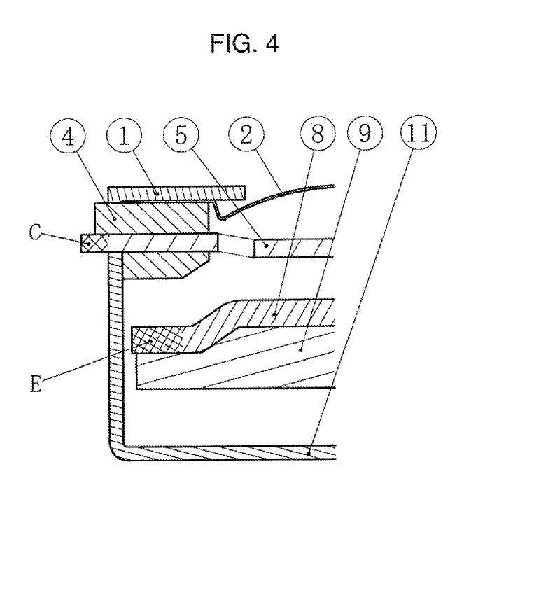

FIG. 1 is an overall perspective view of a multifunctional vibration actuator according to an embodiment of the present invention, FIG. 2 is a lateral cross-sectional view taken along a line A-A′ of FIG. 1, FIG. 3 is an exploded perspective view of the multifunctional vibration actuator of FIG. 1, and FIG. 4 is an expanded view of the vicinity of a protruding portion of FIG. 2. Here, some background lines are omitted in FIG. 2.

As shown in FIGS. 1, 2, and 4, the multifunctional vibration actuator according to the present embodiment has a structure in which a protruding portion C of a suspension 5 and a housing 4 protrude from a cover 11. Accordingly, when a load is applied in a thickness direction, the suspension 5 receives the load, and falling down of the housing 4 against the cover 11, which occurs by a deformation when an uneven load is applied, is prevented by the protruding portion C.

Also, as shown in FIGS. 2 and 3, the multifunctional vibration actuator according to the present embodiment has a dynamic structure that is driven by a magnetic force acting between a sound reproducing portion, which includes a diaphragm 2 and a voice coil 3, and a magnetic circuit portion, which includes a pole piece 6, a magnet 7, a yoke 8 and a weight 9, and is supported on the housing 4 via the suspension 5. Here, the magnet 7 is magnetized in a thickness direction, and the pole piece 6, the yoke 8, and the suspension 5 are formed of a magnetic material. Accordingly, the multifunctional vibration actuator according to the present embodiment performs sound reproduction by setting a frequency band of an input signal to the voice coil 3 to a vibration frequency band of the diaphragm 2 and generates sensory vibration by setting the frequency band of the input signal to a vibration frequency band of the magnetic circuit portion supported via the suspension 5.

Also, according to the structure of the present embodiment, the diaphragm 2 is fixed by being inserted between a grill 1 and the housing 4. As such, according to the structure of the present embodiment, unevenness generated when attaching the diaphragm 2 may be suppressed, thereby satisfactorily performing sound reproduction according to stable fixation strength. Moreover, by attaching the grill 1 to an outer periphery section of the diaphragm 2, an inner wall of an attached case body and the diaphragm 2 may not contact each other when assembling the diaphragm 2 to the attached case body, and thus a sound pressure may be prevented from being decreased during the sound reproduction.

Also, as shown in FIG. 2, in the magnetic circuit portion according to the present embodiment, the voice coil 3 of the sound reproducing portion is positioned in a magnetic gap g formed by an end of the pole piece 6 and an inner periphery of the suspension 5. Accordingly, sound reproduction and vibration generation may be performed at high magnetic efficiency. In addition, the yoke 8 has a step shape corresponding to deformation of the suspension 5 when sensory vibration is generated. Accordingly, the multifunctional vibration actuator may have an overall thin profile without having to decrease an operating range of the suspension 5.

Also, in the present embodiment, the weight 9 is formed and fixed conforming to a lower step shape of the yoke 8. Accordingly, it is possible to decrease detachment of a weight during an impact, such as a fall, since a fixation area is increased, compared with a conventional cylindrical weight. In addition, by setting a fixation location of the suspension on the yoke 8, an inner periphery of the suspension 5 may be used as a magnetic path, and thus the magnetic circuit portion may be thinned and amplitude may be increased when sensory vibration is generated.

Also, as shown in FIGS. 2, 3, and 4, an outer periphery section D of the suspension 5 that is integrated to the housing 4 reinforces strength of a housing portion corresponding to the magnetic circuit portion. In more detail, upon an impact, such as a fall, the housing portion reinforced by the outer periphery section D of the suspension 5 contacts a yoke brim portion E, thereby preventing the magnetic circuit portion and the voice coil 3 from contacting each other. Accordingly, not only impact resistance of the magnetic circuit portion itself, but also impact resistance of an entire driving apparatus may be improved.

In addition, as shown in FIGS. 1 and 2, according to the structure of the present embodiment, an air flow rate inside a space below the magnetic circuit portion is limited by narrowing a gap f between an inner wall of the cover 11 and an outer periphery of the magnetic circuit portion. Accordingly, it is possible to use air below the magnetic circuit portion as a damper, and thus vibration characteristics may be stabilized when sensory vibration is generated.

As described above, by using the structure according to the present embodiment, the multifunctional vibration actuator capable of improving load resistance while maintaining high impact resistance and a thin profile may be obtained.

1. A multifunctional vibration actuator having a dynamic structure in which a magnetic circuit portion including a magnet is supported on a housing via a suspension having a plate shape and a cover accommodating the magnetic circuit portion is fixed to the housing, wherein an outer periphery section of the suspension externally protrudes from the cover.

2. The multifunctional vibration actuator of claim 1, wherein the outer periphery section of the suspension is integrally formed with the housing.
